(19) United States
(12) Patent Application Publication
(10) Pub. No.: US 2017/0265267 A1
(43) Pub. Date: Sep. 14, 2017

(54) METHOD FOR SETTING ILLUMINATION LIGHT

(71) Applicant: OSRAM GmbH, Munich (DE)

(72) Inventors: Guido Angenendt, Munich (DE); Inna Zyuzina, Munich (DE)

(21) Appl. No.: 15/453,931

(22) Filed: Mar. 9, 2017

(30) Foreign Application Priority Data
Mar. 10, 2016 (DE) 10 2016 203 897.4

(51) Int. Cl. H05B 33/08; A47G 1/00; G06T 7/90

(52) U.S. Cl. CPC H05B 33/0872; G06T 7/90; A47G 1/00

(57) ABSTRACT

Various embodiments relate to a method for setting the illumination light emitted by an illuminating unit for illuminating an object to be illuminated, wherein, from a color image of the object to be illuminated, recorded by means of a digital camera, a mean value color locus is ascertained from the respective pixel color information items for a pixel set containing at least some of the pixels of the color image, an associated white light color locus with the most similar correlated color temperature is ascertained for said mean value color locus and wherein, further, the illumination light is selected in such a way that an illumination light color locus of the illumination light substantially corresponds to the white light color locus.

### CROSS-REFERENCE TO RELATED APPLICATION

This application claims priority to German Patent Application Serial No. 10 2016 203 897.4, which was filed Mar. 10, 2016, and is incorporated herein by reference in its entirety.

### TECHNICAL FIELD

Various embodiments relate generally to a method for setting the illumination light emitted by an illuminating unit for illuminating an object to be illuminated.

### BACKGROUND

The illuminating unit forming the subject matter of the method is configured in such a way that the illumination light color locus of the illumination light is selectable, at least within certain limits. That is to say, the illuminating unit is typically constructed from a plurality of different light sources, the respectively emitted light of which in each case has a different color. The illumination light then emerges as a mixture of the light emitted by the individual light sources, said light sources together spanning a color space in this way. Within said color space, the illumination light color locus may then be set by modifying the relative components of the illumination light constituted by the individual light sources with their respectively emitted light.

### SUMMARY

Various embodiments relate to a method for setting the illumination light emitted by an illuminating unit for illuminating an object to be illuminated, wherein, from a color image of the object to be illuminated, recorded by means of a digital camera, a mean value color locus is ascertained from the respective pixel color information items for a pixel set containing at least some of the pixels of the color image, an associated white light color locus with the most similar correlated color temperature is ascertained for said mean value color locus and wherein, further, the illumination light is selected in such a way that an illumination light color locus of the illumination light substantially corresponds to the white light color locus.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a schematic illustration of a color image constructed from a multiplicity of pixels;

FIG. 2 shows a mean value color locus ascertained from a color image and an associated white light color locus of most similar color temperature in a CIE standard chromaticity diagram; and

FIG. 3 shows an illuminating apparatus according to the invention in a schematic view.

### DESCRIPTION

The following detailed description refers to the accompanying drawings that show, by way of illustration, specific details and embodiments in which the invention may be practiced.

Below, the invention is explained in more detail on the basis of an embodiment, wherein the individual features within the scope of the coordinate claims may also be essential to the invention in different combinations and wherein no distinction is continued to be made in detail between the different claim categories.

Various embodiments specify a method for setting the illumination light emitted by an illuminating unit and specify a correspondingly configured illuminating apparatus (including an illuminating unit).

In various embodiments, a method for setting the illumination light emitted by an illuminating unit for illuminating an object to be illuminated is provided. The illuminating unit is designed in such a way that an illumination light color locus of the illumination light is selectable within a color space in a CIE standard chromaticity diagram. In the method: i) a color image of the object to be illuminated being recorded by a digital camera, said color image being constructed from a multiplicity of pixels with a respective pixel color information item; ii) a mean value color locus being ascertained from the respective pixel color information items for a pixel set containing at least some of the pixels, said mean value color locus being averaged over the pixel set; iii) a white light color locus belonging to the mean value color locus being ascertained, said white light color locus having the most similar correlated color temperature to the mean value color locus in the CIE standard chromaticity diagram; iv) the illuminating unit being configured in such a way that the illumination light color locus of the illumination light in the CIE standard chromaticity diagram is spaced apart from the white light color locus by at most 0.02 in terms of absolute value. An illuminating device includes a corresponding illuminating unit, an evaluating unit and a control unit. The evaluating unit is configured to process a color image of the subject to be illuminated, recorded by digital camera and constructed from a multiplicity of pixels with a respective pixel color information item, in a method according to ii) and iii) above. The control unit is configured to actuate the illuminating unit during operation in such a way that the illumination light color locus of the illumination light is spaced away from the white light color locus in the CIE standard chromaticity diagram by at most 0.02 in terms of absolute value.

Various configurations are found in the dependent claims and the remaining disclosure, with the illustration not always distinguishing in detail between apparatus and method or use aspects; in any case, the disclosure should be read implicitly in respect of all claim categories.

In the method according to various embodiments, a color image is recorded using a digital camera and a mean value color locus is ascertained therefrom, specifically from the pixel color information items of the pixels. Here, this mean value color locus may not be formed over all pixels but over only a subset thereof, which, for example, may contain at least 1%, 5% or 10% and (independently thereof) e.g. no more than 95% or 90% of all pixels of the color image. The pixels of the subset are also referred to as “subset pixels” below.

The associated white light color locus of the most similar color temperature, which is also referred to as correlated color temperature, is determined on the basis of the mean value color locus and the illumination light is set in such a way that the illumination light color locus lies as close as possible to said white light color locus. Then, in principle, the illumination light is white light which is matched to the pixels of the pixel set in terms of the color temperature thereof and hence, for example, ultimately matched to a portion of the color image. Now, for example, this portion may be selected e.g. manually by a user in such a way that only the pixels actually relating to the object to be illuminated are taken into account, with an edge region by contrast not being taken into account. Thus, the illumination light may e.g. be optimized to the actual object to be illuminated.

In various embodiments, the object to be illuminated is an image displayed in a museum or a gallery, for example a painting or else a drawing/graphic or photograph; however, in general, this may also relate to a sculpture or even to a television or cinematic presentation or to a live performance (theater, stage). In order to prevent confusion between the terms in relation to the “color image”, reference is predominantly made below to “painting” instead of “image”, but painting should equally be also read as drawing or graphic or photograph.

Ideally, the painting is photographed when it is already at its actual display location. If the mean value color locus should be determined for the painting overall, only the part of the color image on which e.g. the wall may be seen is excluded. Then, no further attention has to be given to only photographing the painting per se when recording the color image; this would generally require much outlay and would be also difficult for reasons of perspective in the case of large formats. Moreover, it is additionally possible to optimize the illumination light in a targeted manner on a portion of the painting to be illuminated, for example in order to highlight a scene in the image foreground.

Independently thereof, the illumination light is then set in detail in such a way that it is white light as a matter of principle. By way of example, if some of the illumination light is incident on a surrounding, typically white wall, no color impression is produced thereon in the ideal case. In the CIE standard chromaticity diagram, the illumination light color locus and the white light color locus are spaced apart from one another in terms of absolute magnitude by at most 0.02, or by at most 0.015, 0.01, 0.005, 0.001, 0.0005 and 0.0001, with preference increasing along this sequence. In various embodiments, they coincide exactly, but lower boundaries may lie at e.g. at least 0.000001 or 0.00001 for technical reasons.

In various embodiments, the illumination light color locus is freely selectable within the color space, i.e. it may be set in a continuous manner; in general, however, the ability to set may also be realized by way of a multiplicity of discrete color locus values. In general, the specifications in respect of the “CIE standard chromaticity diagram” relate to the CIE standard color system of 1931 (this sets a coordinate system for the observations in the present case; however, an analogous observation would also be possible, for example, in an LMS, RGB, CMYK, HSV and/or LAB color system). The “color space” is that portion of the chromaticity diagram which is technically accessible by the illuminating unit; such a portion is also referred to as color gamut.

The color image created by the digital camera is available digitally; “digital camera” should be read to mean any camera with a digital storage medium as a recording medium; by way of example, this may relate to a digital compact or system camera or to a digital single-lens reflex camera, or else it may relate to the camera of a cellular telephone or tablet computer. By way of example, the “multiplicity” of pixels means at least 10 000 (ten thousand), 100 000, 300 000 or 500 000 pixels, wherein possible upper limits may (independently thereof) lie at e.g. at most 1·10¹², 1·10⁹, 1·10⁸ or 1·10⁷.

In a configuration, the white light color locus in the CIE standard chromaticity diagram is spaced apart from the Planck curve by at most 0.01 in terms of absolute value, or by at most 0.005, 0.001, 0.0005 and 0.0001, with preference increasing along this sequence; lower boundaries may (independently thereof) lie at e.g. at least 0.000001 or 0.00001. Light whose color locus lies in a corresponding region about the Planck curve is considered to be “white light” within the scope of this disclosure; accordingly, the “white light color locus” e.g. also lies in this region about the Planck curve.

In various embodiments, the mean value color locus and the white light color locus lie on a common isothermal line in the CIE standard chromaticity diagram. In the CIE standard chromaticity diagram, the isothermal lines in each case connect the color loci with correspondingly the most similar color temperature (conversely, color loci “with the most similar color temperature” lie on a common isothermal line).

In a configuration, the white light color locus lies precisely at the point of intersection of the isothermal line, on which the mean value color locus lies, with the Planck curve. Speaking figuratively, the mean value color locus is therefore localized in the CIE standard chromaticity diagram and the white light color locus then emerges as the point of intersection of the associated isothermal line with the Planck curve.

In various embodiments, the mean value color locus is determined by virtue of a respective pixel color locus being ascertained initially for the pixels of the pixel set, with the mean value color locus then emerging as mean value of the pixel color loci. When considered in the CIE standard chromaticity diagram, the pixel color loci yield a certain two-dimensional arrangement (like a point cloud), wherein the mean value color locus then may emerge as a centroid of this arrangement (each pixel color locus may be included with the same weighting when ascertaining the centroid). The procedure corresponds to ascertaining a geometric centroid, but with discrete points instead of area elements.

In general, the mean value color locus may also be ascertained, for example, by virtue of the pixel set initially being subdivided into subsets with in each case a plurality of pixels; then, a respective partial mean value color locus may be determined for each of the subsets and the mean value color locus is subsequently ascertained therefrom. However, the mean value color locus is preferably determined directly from the pixel color loci of the pixel set.

As already mentioned at the outset, the pixel set is a subset in a configuration, said subset only containing some of the pixels of the color image.

In a configuration, the subset is formed by virtue of, for at least some of the pixels of the color image (preferably for all of the pixels thereof), the respective pixel color locus in each case being assigned to one of a plurality of mutually disjoint standard chromaticity diagram regions. The standard chromaticity diagram is subdivided with a certain grid-size into color regions (e.g. “mustard yellow”, “yellow-green”, “light green”, etc.) by way of the standard chromaticity diagram regions. Each of the examined pixel color loci is then assigned to one of the standard chromaticity diagram regions (or classified as unassignable). The pixels of a standard chromaticity diagram region are only taken into account when ascertaining the mean value color locus, i.e. a respective color region is therefore only included, if a certain minimum number of pixels, e.g. at least 20, 50, 100, 500 or 1000 pixels, was assigned thereto. Thus, a respective threshold is defined for taking into account at least one of the standard chromaticity diagram regions, e.g. for taking into account all standard chromaticity diagram regions.

In various embodiments, the color image recorded by the digital camera is subjected to an automated image analysis, in which the color image is divided into various image segments. Subsequently, the subset is selected in such a way that the pixels of one of the image segments form the subset pixels. The image analysis is an object recognition, within the scope of which the image is segmented into objects such as e.g. “persons”, “faces”, “meadow”, “water”, “trees”, “leaves”, “sky”, “streets”, “houses”; the objects/image segments need not be contiguous from an area point of view and there may also be non-assigned intermediate regions. Then, the mean value color locus is determined for the pixels of one of the objects. In a simple application, it is possible, for example, for the painting to be illuminated to be classified as an object itself in an automated manner and, for example, then to be separated from the background as a substantially rectangular or trapezoidal object. However, there may also be an automated further subdivision of the painting to be illuminated, as sketched out above (into foreground and background, etc.).

In various embodiments, the color image recorded by the digital camera is subjected to automated image analysis and the color image is once again subdivided into various image segments (see above), with at least a first subset and a second subset, each part of the pixel set, being selected in such a way that the share of the pixels contained in the first subset forms a first one of the image segments and the share of the pixels contained in the second subset forms a second one of the image segments. The pixels of the first subset and the pixels of the second subset are then weighted to a different extent when ascertaining the mean value color locus.

When “weighting to a different extent,” the first subset and/or the second subset are not included in the mean value color locus in a manner proportional to the number of pixels therein; instead, they are included less than or more than proportionally; for example, one subset is included more than proportionally and the other one is included less than proportionally. In various embodiments, the weighting correlates to a classification in terms of content of the respective image segments such that, for example, “persons”/“faces” (generally “painting foreground”) may be weighted more strongly than the painting background (e.g. “sky”, etc.).

In a configuration, the color image recorded by the digital camera is supplied to step ii) (ascertaining the mean value color locus), mentioned at the outset, in a raw data format; by way of example, it is also already recorded in the raw data format. That is to say, the data are stored or supplied to the method according to the invention without further processing, i.e. without changing the pixel color information items, after digitization in the recording process.

In various embodiments, a digital color film, constructed from a plurality of individual images, of the object to be illuminated is recorded by way of the digital camera. Then, the color image is one of the individual images and even further ones of the individual images are evaluated in accordance with processes ii) and iii) as claimed in claim 1; thus, a respective mean value color locus is ascertained per individual image for a respective pixel set in a manner disclosed presently. Specifically, it is not expressly necessary to evaluate each individual image in the process, but it is possible also to only take e.g. each tenth or each one hundredth individual image for this purpose.

The evaluation results of the individual individual images may be related to one another such that e.g. the time curve of the mean value color locus is evaluated thus. By way of example, a change therein may only be converted into a modified illumination light if a modified mean value color locus prevails over a certain period of time; by way of example, this can prevent flickering of the illumination light on account of changes that are too fast. Thus, (temporal) thresholds are defined, e.g. at least one second or at least ten seconds. The time curve may also be considered to be, for example, a moving average. By way of example, in order to avoid feedback, illumination may also always be carried out with the same reference light, e.g. for a duration lying below the human perception threshold in each case, at those times at which the individual images are recorded in each case.

The “color film” embodiment should furthermore be specifically disclosed independently of item ii) of the main claim as well, i.e. independently of ascertaining the mean value color locus within a respective individual image. This is because, for example, the mean value color locus may also be evaluated over a plurality of individual images, wherein, for example, a separate decision may be made for each individual image in respect of which pixels should be taken into account; i.e., the pixels taken into account may also differ from individual image to individual image. The mean value color locus may then be e.g. determined together for pixels gathered from a plurality of individual images, for example in a manner described per se above.

Various embodiments also relate to a computer program product (e.g. a data medium, storage medium, a computer-readable medium or a signal) including a computer program including software means for running a method disclosed presently when the computer program is executed in an automatization system and the color image is loaded into the automatization system. By way of example, the automatization system may be part of a cellular telephone (smartphone) or of a tablet computer (also referred to as “mobile appliance” below), e.g. a processor, and the software means are then embedded in an application program.

In general, the calculation, for example, may also at least in part take place in a cloud, which an installed application program then preferably accesses. Independently of whether the application program undertakes the (complete) calculation itself or whether it is coupled to a cloud, the application program may directly access the digital camera of the mobile appliance. The white light color locus or illumination light color locus ascertained after carrying out the method according to various embodiments may then be transferred to the illuminating unit or to an associated control unit by way of a radio interface, e.g. WLAN or Bluetooth.

As already mentioned at the outset, various embodiments also relate to an illuminating apparatus including an illuminating unit, an evaluating unit and a control unit, with the evaluating unit ascertaining the white light color locus and the control unit actuating the illuminating unit accordingly. By way of example, the mobile appliance with the application program would be the evaluating unit in the aforementioned example. However, evaluating unit and control unit may also be integrated further, for example be arranged in a common housing or else have a common processor. The illuminating apparatus may then nevertheless include an interface, preferably a radio interface (see above), by means of which the color image may be supplied to the evaluating unit, for example from a mobile appliance.

However, the digital camera may also be part of the illuminating apparatus in various embodiments; for example, it may be arranged in a common housing with the illuminating unit, integrated therewith from a structural point of view. By way of example, such an illuminating apparatus may be aligned onto a wall with the illumination region thereof and the capturing region of its camera (the two substantially overlap) when assembled on the ceiling. If a painting is then hung or changed at this wall, a setting process may be actuated for the illuminating apparatus, for example by radio control, within the scope of which the ideal illumination light color locus is set.

In a configuration, the illuminating apparatus includes a plurality of LEDs, which are each designed for emitting LED light with a different color in each case. By modifying the relative components of the different colors in the illumination light, it is possible to set the illumination light color locus thereof; reference is also expressly made to the explanations in the acknowledgment of the background section. In various embodiments, provision is made of at least three different LEDs for the colors red (r), green (g) and blue (b). In order to increase the light flux and/or the color quality, provision may additionally also be made of an LED for white (w), e.g. cold white (kw) and/or warm white (ww). By way of example, an LED for yellow (y) may also be provided. That is to say, possible combinations are e.g. rgb, rgbw, rgb(kw)(ww), rgby, rgbyw, rgby(kw)(ww).

The change of the relative component of a respective LED light with a specific color in the illumination light may be carried out by adapting the mean output power of the respective LED. By way of example, the mean output power may also be changed in a pulse-width modulated manner, i.e. by changing the duty cycle. A (non-pulsed) continuous duration is preferable, i.e. in which the output powers of the individual LEDs are constant if an illumination light with a specific illumination light color locus is emitted.

An LED is a light-emitting diode, with the term “LED” being able to refer both to the LED chip per se and to a packaged LED chip. The LED light may be the light emitted by the LED chip itself, which is then also referred to as primary light; however, in the case of an LED with a wavelength-converting phosphor (conversion LED), this may also relate to the conversion light emitted by the phosphor, possibly mixed with a non-converted part of the primary light. The LEDs may be inorganic light-emitting diodes, e.g. on the basis of InGaN or AlInGaP, or organic LEDs (OLEDs, e.g. polymer OLEDs). Naturally, a plurality of LEDs may also be provided per the color, said LEDs then e.g. having the same design as one another. In general, “a”/“an” within the scope of this disclosure should, provided nothing to the contrary is specified, be read as the indefinite article and, in this respect, as “at least one”.

Various embodiments also relate to the use of an illuminating device disclosed presently for illumination purposes, e.g. for illuminating an object of the fine arts, e.g. an image, for example a painting or a photograph.

In an exemplary use, a plurality of objects to be illuminated are illuminated in succession and the illumination light is set separately for each of these objects to be illuminated. Here, the illumination “in succession” may also extend by all means over a period of time of several weeks or months, which is illustrated by the example of museum illumination, for example if a new painting is exhibited or the illumination situation changes. The illuminating unit, e.g. integrated with the control unit, further preferably integrated with an evaluating unit, may be fixedly installed relative to a region to be illuminated (e.g. a wall), in which the objects to be illuminated are then arranged in succession, even though said illuminating unit may, in general, also be part of a transportable luminaire.

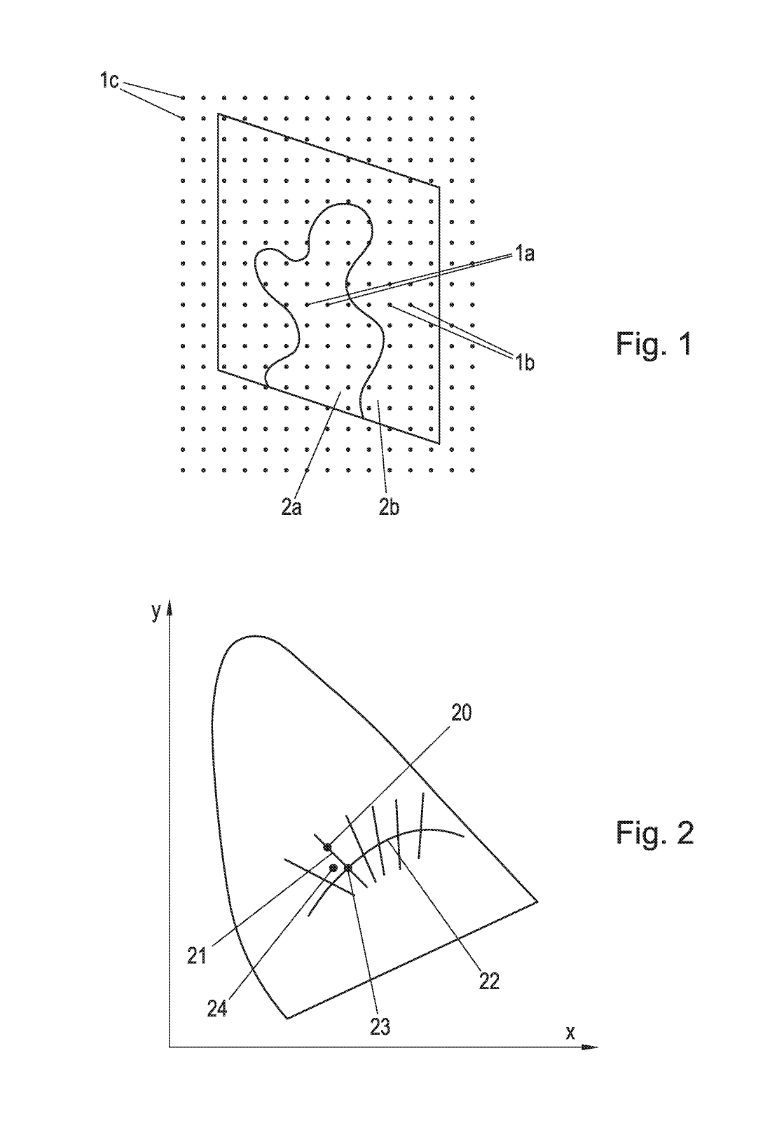

FIG. 1 shows a schematic view of a color image recorded by a digital camera, said color image being constructed from a multiplicity of pixels 1. Each of the pixels 1 contains a pixel color information item, from which a respective pixel color locus emerges for each pixel 1. The color image constructed from the pixels 1 shows an image 2 exhibited on a wall in a gallery as an object to be illuminated, namely a painting in the present case. The image 2 is made up of a figure in the image foreground 2a and the image background 2b. Within the scope of an image analysis, the color image is now subdivided into various image segments, namely initially those pixels 1a, b, which reproduce the image 2 (the painting). The pixels 1c which reproduce the wall differ therefrom.

Since the illumination of the image 2 should be optimized, the pixels 1c remain unconsidered and only a subset constructed from the pixels 1a, b is supplied to the further evaluation. The subset therefore corresponds to precisely those pixels 1a, b which in fact relate to the image 2 (the painting). A more detailed subdivision would also still be possible such that, for example, it is thus possible to evaluate only the pixels 1a relating to the image foreground 2a; however, an evaluation relating to the entire image 2 is assumed in the present case.

A mean value color locus 20 is ascertained for the pixels 1a, b of the subset, cf. FIG. 2 for illustrative purposes. Said figure shows a CIE standard chromaticity diagram (CIE 1931 color space). Plotting the pixel color loci of the pixels 1a, b on this standard chromaticity diagram yields a two-dimensional point cloud, the centroid of which then is the mean value color locus 20.

The mean value color locus 20 lies on an isothermal line 21, which connects color loci with the most similar color temperature to one another. Further, the Planck curve 22 is plotted in the CIE standard chromaticity diagram and a white light color locus 23 emerges as a point of intersection between the Planck curve 22 and the isothermal line 21 (further isothermal lines for other color temperatures are also plotted for illustrative purposes). If the mean value color locus 20 should lie beyond the Planck curve 22 (which, as a rule, is not the case), i.e. lie to the left or right thereof in the figure, it is possible to set e.g. a standard light color locus 25, such as e.g. D65 (plotted in the schematic figure), D55 or D75 in a routine.

The mean value color locus 20 and the white light color locus 23 have the most similar color temperature. If an illumination light with an illumination light color locus equal to the white light color locus 23 is selected for illuminating the image 2, the colors of the image 2 are, on the one hand, emphasized particularly well; on the other hand, however, illumination is not carried out with colored light because the illumination light color locus lies on the Planck curve 22, i.e., in particular, no color impression is registered on the (white) wall surrounding the image 2.

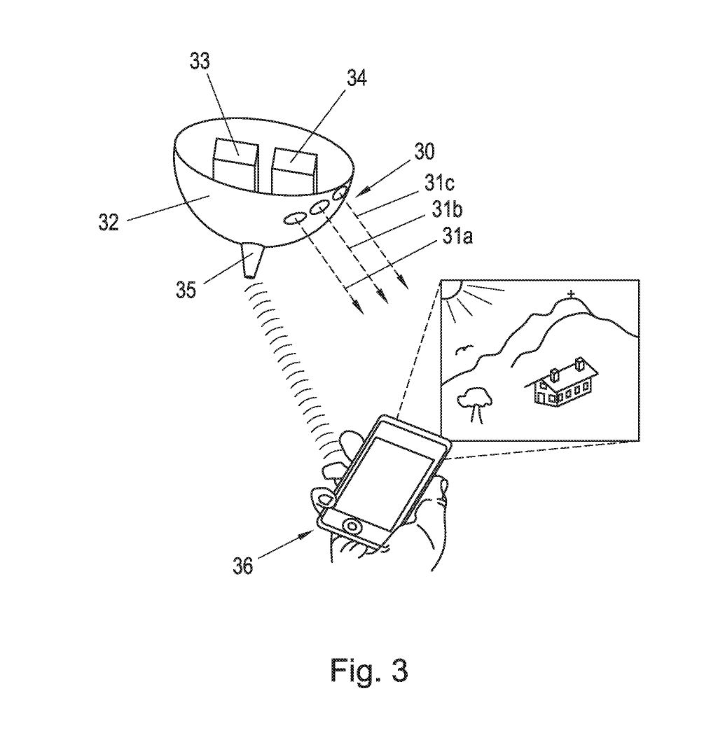

Finally, FIG. 3 illustrates an illuminating unit 30 in a schematic illustration, said illuminating unit including three different LEDs (not depicted in detail) as light sources, which differ in terms of the color of the respectively emitted LED light 31a, b, c (the present illustration relates to three colors; in reality, five different types of LED of different color may be provided, see above). The LED light 31a, b, c yields the illumination light 31 as a mixture, the illumination light color locus of which is adjustable by modifying the relative components.

An evaluating unit 33 and a control unit 34 are integrated with the illuminating unit 30 in a common housing 32. The color image is supplied to the evaluating unit 33 by way of a radio module 35 and the pixels 1a, b underlying the evaluation are then ascertained in an automated manner. Finally, the control unit 34 controls the illuminating unit 30 in such a way that the illumination light color locus corresponds to the white light color locus 23 ascertained for the color image. In this example, the cellular telephone 36 (smartphone) only serves to record and transfer the color image to the evaluating unit 33.

As an alternative to this integration of the evaluating unit 33 in the housing 32 together with the control unit 34, the evaluation may also already take place in the cellular telephone 36. To this end, a separate application program is installed on the cellular telephone 36 or, alternatively, on a tablet computer. This application program is used to ascertain the white light color locus 23 and the latter is then transferred to the control unit 34 way of the radio module 35, said control unit then correspondingly configuring the illumination light color locus.

### LIST OF REFERENCE SIGNS

Pixels 1a, b, c
Image 2
Image foreground 2a
Image background 2b
Mean value color locus 20
Isothermal line 21
Planck curve 22
White light color locus 23
Standard light color locus 24
Illuminating unit 30
Illumination light 31
LED light 31a, b, c
Housing 32
Evaluating unit 33
Control unit 34
Radio module 35
Cellular telephone 36

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method for setting the illumination light emitted by an illuminating unit for illuminating an object to be illuminated,
said illuminating unit being designed in such a way that an illumination light color locus of the illumination light is selectable within a color space in a CIE standard chromaticity diagram,
the method comprising:
i) recording a color image of the object to be illuminated by a digital camera, said color image being constructed from a multiplicity of pixels with a respective pixel color information item;
ii) ascertaining a mean value color locus from the respective pixel color information items for a pixel set containing at least some of the pixels, said mean value color locus being averaged over the pixel set;
iii) ascertaining a white light color locus belonging to the mean value color locus, said white light color locus having the most similar color temperature to the mean value color locus in the CIE standard chromaticity diagram;
iv) wherein the illuminating unit is configured in such a way that the illumination light color locus of the illumination light in the CIE standard chromaticity diagram is spaced apart from the white light color locus by at most 0.02 in terms of absolute value.

2. The method of claim 1,
wherein the white light color locus in the CIE standard chromaticity diagram is spaced apart from the Planck curve by at most 0.01 in terms of absolute value.

3. The method of claim 1,
wherein the mean value color locus and the white light color locus lie on a common isothermal line in the CIE standard chromaticity diagram.

4. The method of claim 3,
wherein the white light color locus lies at the point of intersection of the common isothermal line and the Planck curve in the CIE standard chromaticity diagram.

5. The method of claim 1,
wherein the mean value color locus is ascertained by virtue of a respective pixel color locus initially being ascertained in each case for the pixels of the pixel set from the respective pixel information item and the mean value color locus then being determined as mean value of the pixel color loci.

6. The method of claim 1,
wherein the pixel set is a subset which only contains some of the pixels of the color image.

7. The method of claim 6,
wherein the subset is formed by virtue of, for at least some of the pixels, the respective pixel color locus thereof in each case being assigned to one of a plurality of mutually disjoint standard chromaticity diagram regions, wherein the pixels assigned to one of the standard chromaticity diagram regions are only taken into account when ascertaining the mean value color locus if a minimum number of pixels is assigned to the respective standard chromaticity diagram region.

8. The method of claim 6,
wherein an image analysis is carried out in an automated manner on the color image recorded by the digital camera, within the scope of which the color image is subdivided into various image segments, wherein the subset is then selected in such a way that the share of the pixels contained therein forms one of the image segments.

9. The method of claim 1,
wherein an image analysis is carried out in an automated manner on the color image recorded by the digital camera, within the scope of which the color image is subdivided into various image segments, wherein at least a first subset of pixels and a second subset of pixels, which are disjoint from one another and in each case part of the pixel set, are selected in such a way that the share of the pixels contained in the first subset forms a first one of the image segments and the share of the pixels contained in the second subset forms a second one of the image segments, and wherein the pixels of the first subset and the pixels of the second subset are weighted to a different extent when ascertaining the mean value color locus.

10. The method of claim 1,
wherein a color film, constructed from individual images, of the object to be illuminated is recorded by way of the digital camera, wherein the color image is one of the individual images and even further ones of the individual images are evaluated in accordance with processes ii) and iii).

11. The method of claim 1,
wherein the object to be illuminated is an object from the fine arts.

12. The method of claim 11,
wherein the object from the fine arts is an image.

13. The method of claim 1,
wherein a plurality of objects are illuminated in succession; and
wherein the respective illumination light emitted by the illuminating unit for each of the objects to be illuminated is set separately for the respective object to be illuminated.

14. The method of claim 11,
performed in a museum or a gallery.

15. A computer program product comprising a computer program comprising software means for running a method when the computer program is executed in an automatization system and a color image of an object to be illuminated, constructed from a multiplicity of pixels with a respective pixel color information item, which was recorded by digital camera is loaded into the automatization system, the method comprising:
ascertaining a mean value color locus from the respective pixel color information items for a pixel set containing at least some of the pixels, said mean value color locus being averaged over the pixel set; and
ascertaining a white light color locus belonging to the mean value color locus, said white light color locus having the most similar color temperature to the mean value color locus in the CIE standard chromaticity diagram.

16. An illuminating apparatus comprising
an illuminating unit for illuminating an object to be illuminated with illumination light;
an evaluating unit; and
a control unit;
wherein the illuminating unit is designed in such a way that an illumination light color locus of the illumination light is selectable within a color space in a CIE standard chromaticity diagram; and
wherein the evaluating unit is configured to process a color image of the object to be illuminated, recorded by digital camera and constructed from a multiplicity of pixels with a respective pixel color information item, in a method, comprising:
ascertaining a mean value color locus from the respective pixel color information items for a pixel set containing at least some of the pixels, said mean value color locus being averaged over the pixel set; and
ascertaining a white light color locus belonging to the mean value color locus, said white light color locus having the most similar color temperature to the mean value color locus in the CIE standard chromaticity diagram;
wherein the control unit is configured to actuate the illuminating unit during operation in such a way that the illumination light color locus of the illumination light is spaced away from the white light color locus in the CIE standard chromaticity diagram by at most 0.01 in terms of absolute value.

17. The illuminating apparatus of claim 16, further comprising:
a digital camera for recording the color image of the object to be illuminated.

18. The illuminating apparatus of claim 16,
wherein the illuminating unit comprises a multiplicity of different LEDs for emitting respective LED light with a different color in each case, the illumination light emitted by the illuminating apparatus being composed of a mixture of said LED light.
